(19) United States
(12) Patent Application Publication
(10) Pub. No.: US 2010/0022222 A1
(43) Pub. Date: Jan. 28, 2010

(54) SYSTEM FOR PROVIDING SEARCH SERVICES OVER MOBILE MESSAGING

(75) Inventor: Jiatong Li, Kowloon (HK)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/180,782

(22) Filed: Jul. 28, 2008

(51) Int. Cl. H04M 3/42

(52) U.S. Cl. 455/414.1

(57) ABSTRACT

A system is described for providing search services over mobile messaging. The system may include a processor, a memory and an interface. The memory may store a search result and a mobile advertisement related to the search result. The mobile advertisement may include a link to a mobile web page related to the mobile advertisement. The interface may communicate with the device over a mobile messaging service. The processor may receive a first mobile message from the mobile device via the interface. The first mobile message may include a search query. The processor may retrieve the search result of the search query and may retrieve the mobile advertisement related to the search result. The processor may generate a second mobile message containing the search result and the mobile advertisement. The processor may provide the second mobile message to the mobile device via the interface.

### TECHNICAL FIELD

The present description relates generally to a system and method, generally referred to as a system, for providing search services over mobile messaging, and more particularly, but not exclusively, to providing search results and serving targeted advertisements over mobile messaging.

### BACKGROUND

The mobile phone may be increasingly important as an information and content access device. Currently there may be twice as many mobile communication devices as personal computers. Mobile operators may be increasingly looking to high value data services as a way to overcome the continuing voice average revenue per user decline. Billions of dollars may be being spent globally on wireless licenses with billions more in investments in the pipeline for development of infrastructure and services by wireless service and content providers. Carriers may be introducing new data, content and multimedia services as a means of generating new revenue stream, reversing negative average revenue per user (“ARPU”) trends, retaining and attracting customers as well as increasing returns on investment, and extending and differentiating their service offering to consumers. The emergence of these wireless technologies may be creating unique opportunities for wireless carriers, advertisers and publishers to generate additional revenue streams through new and existing customers.

### SUMMARY

A system is disclosed for providing search services over mobile messaging. The system may include a processor, a memory and an interface. The memory may be operatively connected to the processor and the interface and may store a search result and a mobile advertisement related to the search result. The mobile advertisement may include a link to a mobile web page related to the mobile advertisement. The interface may be operatively connected to the memory and may communicate with the device over a mobile messaging service. The processor may be operatively connected to the memory and the interface. The processor may receive a first mobile message from the mobile device via the interface. The first mobile message may include a search query. The processor may retrieve the search result of the search query and may retrieve the mobile advertisement related to the search result. The processor may generate a second mobile message containing the search result and the mobile advertisement. The processor may provide the second mobile message to the mobile device via the interface.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for providing search services over mobile messaging.

FIG. 2 is block diagram of a simplified view of a network environment implementing the system of FIG. 1 or other systems for providing search services over mobile messaging.

FIG. 3 is a block diagram of an implementation of the system of FIG. 1 or other systems for providing search services over mobile messaging.

FIG. 4 is a flowchart illustrating operations of providing a search result and targeted advertisement over a mobile message in the system of FIG. 1 or other systems for providing search services over mobile messaging.

FIG. 5 is a flowchart illustrating network operations of providing a search result and targeted advertisement to a user over mobile messaging in the systems of FIG. 1, or other systems for providing search services over mobile messaging.

FIG. 6 is a flowchart illustrating operations of displaying search results in the system of FIG. 1, or other systems for providing search services over mobile messaging.

FIG. 7 is a flowchart illustrating operations of providing a link to search results in a mobile message in the system of FIG. 1, or other systems for providing search services over mobile messaging.

FIG. 8 is a flowchart illustrating operations of a mobile network operator in the system of FIG. 1, or other systems for providing search services over mobile messaging.

FIG. 9 is an illustration of a mobile device displaying a mobile message containing a search query in the system of FIG. 1 or other systems for providing search services over mobile messaging.

FIG. 10 is an illustration of a mobile device displaying a mobile message containing a mobile search result and a targeted mobile advertisement in the system of FIG. 1 or other systems for providing search services over mobile messaging.

FIG. 11 is an illustration a general computer system that may be used in a system for providing search services over mobile messaging.

### DETAILED DESCRIPTION

A system and method, generally referred to as a system, relate to providing search services over mobile messaging, and more particularly, but not exclusively, to providing search results and serving targeted advertisements over mobile messaging. The principles described herein may be embodied in many different forms.

The system may allow a user to submit a search from a mobile device through a mobile message, such as a short messaging service (“SMS”) message. The user may send a mobile message containing a search query to a service provider. The service provider may retrieve the search results and an advertisement targeted to the search results. The service provider may transform the search results and advertisement into a mobile message, such as a wireless application protocol (“WAP”) push message. The service provider may encode each search result and advertisement in the mobile message with a service indication. The service indication may cause the mobile device of the user to perform an action, such as open a browser to a related mobile web page, when the user clicks on the search result or advertisement within the mobile message. The service provider may send the message, with the search results and advertisement, to the user. The user may click on a search result or advertisement to view a related mobile web page.

Alternatively or in addition the system may allow a service provider to generate a mobile page containing the search results and an advertisement. The mobile page may be formatted to display properly on the mobile device of the user. The service provider may generate a mobile message containing a link to the mobile page encoded with a service indication. The service provider may provide the mobile message with the encoded link to the user. The service indication may cause the mobile device of the user to open a browser, such as a microbrowser, to the mobile web page containing the search results and mobile advertisement when the user clicks on the link.

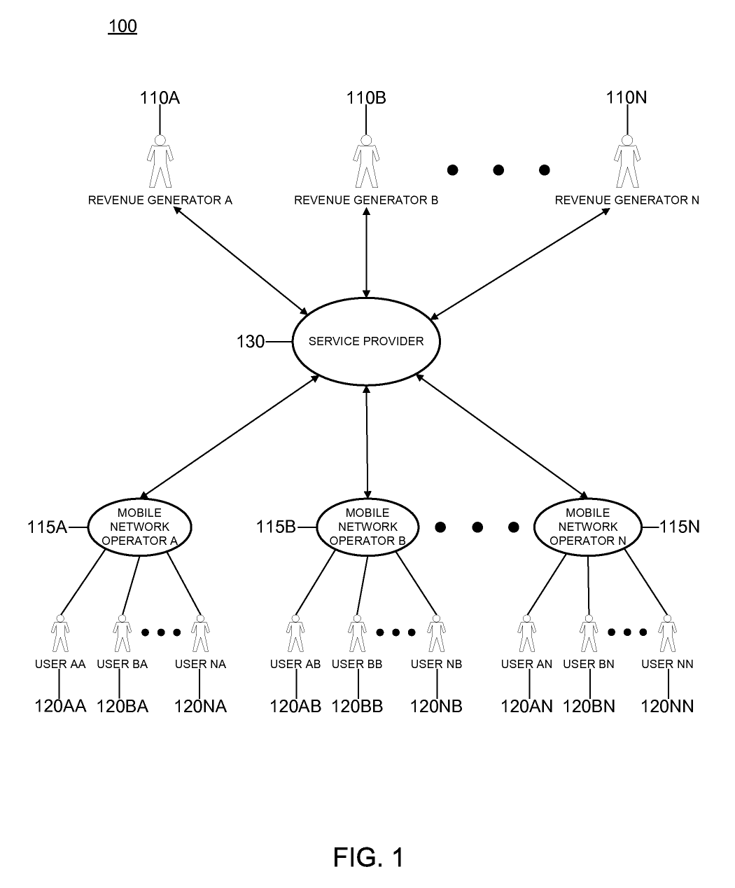

FIG. 1 provides a general overview of a system 100 for providing search services over mobile messaging. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as mobile advertisers, a service provider 130, such as a portal, one or more mobile network operators (“MNOs”) 115A-N, more commonly referred to as mobile carriers, or simply carriers, and one or more users 120AA-NN, such as mobile subscribers or consumers. The service provider 130 may implement an advertising campaign management system incorporating an auction based and/or non-auction based advertisement serving system.

The revenue generators 110A-N may pay the service provider 130 to serve, or display, advertisements of their goods or services, such as mobile advertisements, to the users 120AA-NN, such as over mobile messaging, mobile web, the Internet, or generally any venue for displaying advertisements. The advertisements may include sponsored listings, banners ads, popup advertisements, mobile messaging advertisements, or generally any way of attracting the users 120AA-NN to the web site or mobile site of the revenue generators 110A-N. The users 120AA-NN may utilize the services of the service provider 130 through web applications, mobile applications, such as mobile messaging applications, or standalone applications.

The service provider 130 may maintain a mobile portal and/or a web portal, such as a search site, where the service provider 130 may display advertisements of the revenue generators 110A-N to the users 120AA-NN. In the case of a mobile portal, the service provider 130 may share revenue with the mobile network operators MNOs 115A-N of the users 120AA-NN for displaying advertisements of the revenue generators 110A-N via their mobile networks, such as within a mobile message sent through their mobile network. Alternatively or in addition the service provider 130 may share revenue with individual publishers for displaying advertisements of the revenue generators 110A-N on their mobile and/or web sites.

The MNOs 115A-N may provide a mobile network to the users 120AA-NN which may provide a variety of services to the users 120AA-NN, such as the ability to send and receive phone calls, send and receive mobile messages, to access the internet and/or the mobile web, or generally any service that may be implemented on a mobile device. The MNOs 115A-N may store data describing the users 120AA-NN, such as billing addresses, call histories, messaging histories, or generally any data regarding the users 120AA-NN that may be available to the MNOs 115A-N.

The service provider 130 may provide an application programming interface (“API”) to the MNOs 115A-N to allow the MNOs 115A-N to access the mobile search and mobile advertising services of the service provider 130. The MNOs 115A-N may make a call to the API to retrieve search results or mobile advertisements from the service provider 130. The MNOs 115A-N may provide the search results and/or advertisements to the user 120AA-NN via mobile messages, such as a WAP push message. A WAP push message may be a specially encoded message including a link to a network address, such as a WAP address. When a mobile device of a user AA 120AA receives a WAP push message, the mobile device may automatically give the user AA 120AA the option of accessing the content stored at the network address, such as through a browser.

The amount the revenue generators 110A-N may pay the service provider 130 may be based on one or more factors. These factors may include impressions, click throughs, conversions, and/or generally any metric relating to the advertisement and/or the behavior of the users 120AA-NN. The impressions may refer to the number of times an advertisement may have been displayed to the users 120AA-NN. The click throughs may refer to the number of times the users 120AA-NN may have clicked through an advertisement to a web site, mobile web site or mobile landing page of one of the revenue generators 110A-N, such as the revenue generator A 110A. The conversions may refer to the number of times a desired action was taken by the users 120AA-NN after clicking though to a web site of the revenue generator A 110A. The desired actions may include submitting a sales lead, making a purchase, viewing a key page of the site, downloading a whitepaper, and/or any other measurable action. If the desired action is making a purchase, then the revenue generator A 110A may pay the service provider 130 a percentage of the purchase.

The users 120AA-NN may be mobile users who may engage in messaging with one another, such as through a short message service (“SMS”), a multimedia messaging service (“MMS”), enhanced messaging service (“EMS”), J-PHONE's Skymail, NTT DOCOMO'S Short Mail, or generally any service for sending messages to/from mobile devices. The mobile messages may be routed through the MNOs 115A-N. The users 120AA-NN may wish to perform mobile searches over the mobile messaging protocols.

The users 120AA-NN may also be consumers of goods or services who may be searching for a business, such as the business of one of the revenue generators 110A-N. Alternatively or in addition the users 120AA-NN may be machines or other servers, such as the third party server 250. The users 120AA-NN may need a user identifier or identification (“user ID”) to access the services of the service provider 130. In order to obtain a user ID the users 120AA-NN may need to supply information describing themselves to the service provider 130, such as the location, gender, or age of the users 120AA-NN, or generally any information that may be required for the users 120AA-NN to utilize the services provided by the service provider 130. The service provider 130 may collect user behavior data from the users 120AA-NN when they are logged in, such as queries searched for by the users 120AA-NN, links clicked on by the users 120AA-NN and/or any user interactions with the services provided by the service provider 130.

The service provider 130 may serve advertisements to the users 120AA-NN, via mobile messages, relevant to the collected user behavior data. For example, if a user AA 120AA performed mobile searches for sports topics, the service provider server 130 may serve a sports related ad to the user AA 120AA. The revenue generators 110A-N may identify categories to associate their advertisements with, such as sports. Alternatively or in addition, the service provider server 130 may perform content matching on the advertisements of the revenue generators 110A-N and identified interests of the user AA 120AA, such as sports.

In the system 100, the revenue generators 110A-N may interact with the service provider 130, such as via a web application. The revenue generators 110A-N may send information, such as billing, website or mobile site and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application.

The users 120AA-NN may also interact individually with the service provider 130, through the mobile network operators 115A-N, such as via a mobile phone or any mobile device capable of communicating with the mobile network operators 115A-N. The users 120AA-NN may interact with the service provider 130 via a mobile web based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however the system 100 may apply to any revenue generators 110A-N who may desire to serve advertisements over mobile devices.

A revenue generator A 110A who is a mobile advertiser may maintain one or more accounts with the service provider 130. For each account the revenue generator A 110A may maintain one or more campaigns. For each campaign the revenue generator A 110A may maintain one or more listings. A listing may include a keyword and one or more mobile message listings. Each mobile message listing may include an advertisement title, an advertisement description, a bid amount and a mobile site uniform resource locator (“URL”), if any. A mobile message listing may represent an association between a keyword and a mobile advertisement. The listing may also include an option to have the advertisement displayed to users over any mobile messages. The revenue generators 110A-N may be able to specify demographic characteristics, such as age, gender, etc, they wish their advertisement to be targeted to. The revenue generators 110A-N may be able to specify a minimum number of mobile messages to have their advertisement attached to per month.

If the revenue generator A 110A does not have a mobile site URL for the MNO A 115A, the revenue generator A 110A may still bid on a keyword for the MNO A 115A. In this case, the service provider 130 may dynamically create a “WAP ad.” The “WAP ad” may be an offer landing page containing the phone number of the advertiser and/or the logo of the advertiser. When a user AA 120AA clicks on the advertisement of the revenue generator A 110A who does not have a mobile site, the user AA 120AA may be taken to a page showing the phone number and/or logo of the revenue generator A 110A. The user AA 120AA may then use their mobile device to call the phone number of the revenue generator A 110A and complete their transaction. The data associated with the “WAP ad” may be stored in the advertisement title and/or the advertisement description fields.

The keywords may represent one or more mobile search terms that the revenue generator A 110A wishes to associate with their advertisement. The advertisement title may represent the data the revenue generator A 110A wishes to be displayed to a user AA 120AA. Alternatively or in addition, the advertisement description may represent the data the revenue generator A 110A wishes to be displayed to a user AA 120AA when the user AA 120AA receives a mobile message containing the keyword. The mobile site URL may represent the link the revenue generator A 110A wishes a user AA 120AA to be directed to upon clicking on the mobile advertisement of the revenue generator A 110A, such as the home page of the revenue generator A 110A. The bid amount may represent a maximum amount the revenue generator A 110A may be willing to pay each time a user AA 120AA may click on the mobile advertisement of the revenue generator A 110A or each time the mobile advertisement of the revenue generator A 110A may be shown to a user AA 120AA, such as in a mobile message.

The revenue generators 110A-N may bid on any messages sent via a particular carrier, or the revenue generators 110A-N may bid on specific search keywords that appear in messages via a particular carrier or network. More detail regarding the aspects of mobile advertising systems, as well as their structure, function and operation, can be found in commonly owned U.S. patent application Ser. No. 11/712,276, filed on Feb. 28, 2007, entitled, “SYSTEM FOR SERVING ADVERTISEMENTS OVER MOBILE DEVICES”, which is hereby incorporated herein by reference in its entirety. The systems and methods herein associated with mobile advertising systems may be practiced in combination with methods and systems described in the above-identified patent application incorporated by reference.

In operation, the user AA 120AA may submit a search query via a mobile message to the MNO A 115A. The MNO A 115A may then request search results and an advertisement from the service provider 130. The MNO A 115A may transform the search results and advertisement into a mobile message, such as a WAP push message. The mobile message may include a service indication, such as a WAP push message service indication, which may cause the mobile device to open a browser, such as a microbrowser. The MNO A 115A may provide the mobile message to the user AA 120AA. If the user AA 120AA opens the mobile message the service indication may allow the user AA 120AA to access the related mobile web pages through a WAP gateway. In one instance, the short message service center (“SMSC”) component of the MNOs 115A-N may receive the mobile message and request the advertisement from the service provider 130. The request may include the search query and information describing the sender, or generally any information that may be used to target an advertisement. The information describing the sender may include the type of mobile device the sender is using, demographic information of the sender, such as gender, age, location of the sender, etc., or generally any information describing the sender that may be used to target an advertisement.

The search query and associated information received by the service provider 130 may be applied to existing client browser targeting mechanisms of the service provider 130. The service provider 130 may use any or all of the received information to target an advertisement, such as targeting the advertisement to the specific mobile device, the user AA 120AA, the time of the day, the location of the user, the source of the message, or generally using any of the information supplied by the MNO A 115A. The search results and advertisement may be communicated back to the MNO A 115A in an extensible markup language (“XML”) format via hypertext transfer protocol (“HTTP”). The MNO 115A may transform the search results and advertisement into a mobile message and may provide the mobile message to the user AA 120AA. The service provider 130 may store data regarding the user AA 120AA and the advertisement. The data may include the demographics of the user AA 120AA and whether the user AA 120AA clicked on the advertisement. The service provider 130 may store additional data if the user AA 120AA clicks on a search result and/or advertisement in the mobile message.

Alternatively or in addition the MNO A 115A may forward the mobile message containing a search query directly to the service provider 130. In this instance the service provider 130 may perform the search and generate a mobile message containing the search results and/or a mobile advertisement. The service provider 130 may provide the mobile message to the MNO A 115A. The MNO A 115A may then send the message to the mobile device of the user AA 120AA.

Alternatively or in addition the content of the search result, or the content of the mobile page linked by the search result, may be targeted with a content matching system. The service provider 130 may implement a content matching system. The content matching system may process the words on a given search result, or page linked to a search result, to determine a set of terms. The set of terms may be the most commonly occurring words, or may be determined by some other factor. The set of terms may then be used to determine which of the content match advertisements to display. The content matching system may use the set of terms to select advertisements, such as by selecting the advertisements which contain the most number of words matching the set of terms. The set of terms may be referred to as a query or a content match query.

More detail regarding the aspects of auction-based systems, as well as the structure, function and operation of the service provider 130, as mentioned above, can be found in commonly owned U.S. patent application Ser. No. 10/625,082, filed on Jul. 22, 2003, entitled, “TERM-BASED CONCEPT MARKET”; U.S. patent application Ser. No. 10/625,000, file on Jul. 22, 2003, entitled, “CONCEPT VALUATION IN A TERM-BASED CONCEPT MARKET” filed on Jul. 22, 2003; U.S. patent application Ser. No. 10/625,001, filed on Jul. 22, 2003, entitled, “TERM-BASED CONCEPT INSTRUMENTS”; and U.S. patent application Ser. No. 11/489,386, filed on Jul. 18, 2006, entitled, “ARCHITECTURE FOR AN ADVERTISEMENT DELIVERY SYSTEM,” all of which are hereby incorporated herein by reference in their entirety. The systems and methods herein associated with ad campaign management may be practiced in combination with methods and systems described in the above-identified patent applications incorporated by reference.

Furthermore, the service provider 130 may generate reports based on the data collected from the users 120AA-NN and communicate the reports to the revenue generators 110A-N to assist the revenue generators 110A-N in measuring the effectiveness of their mobile advertising. The reports may indicate the number of times the users 120AA-NN viewed a mobile advertisement of the revenue generators 110A-N, the number of times a mobile advertisement of the revenue generators 110A-N was clicked on by the users 120AA-NN, or generally any information useful to the revenue generators 110A-N. There may be a separate report for each MNO 115A-N the advertisement of the revenue generator A 110A was displayed on. The reports may also generally indicate any data that may assist the revenue generators 110A-N in measuring the effectiveness of their mobile advertising campaigns.

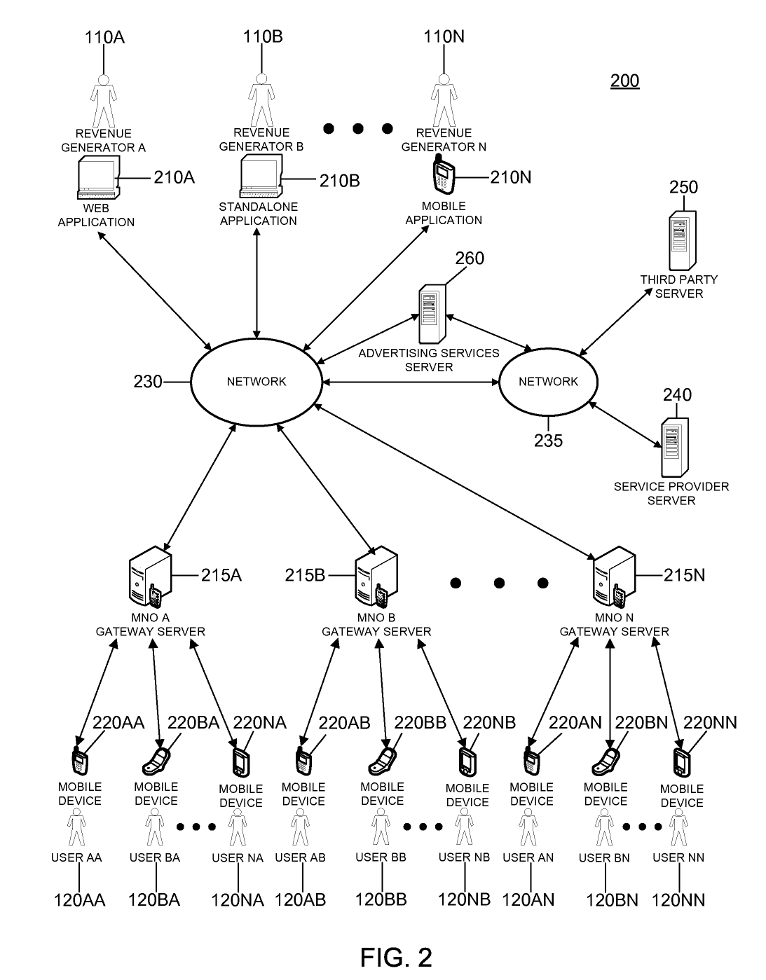

FIG. 2 provides a simplified view of a network environment implementing a system 200 for providing search services over mobile messaging. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, such as mobile messaging applications and/or mobile browsers, which may be running on one or more mobile devices 220AA-NN. The system 200 may also include one or more MNO gateway servers 215A-N, a network 230, a network 235, the service provider server 240, a third party server 250, and an advertising services server 260.

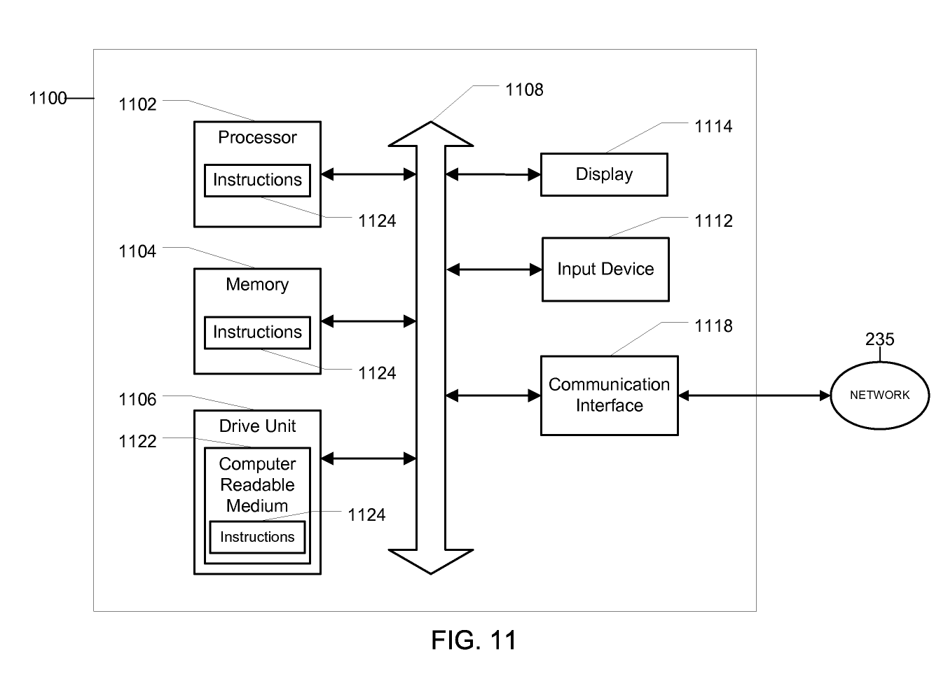

Some or all of the advertisement services server 260, service provider server 240, and third-party server 250 may be in communication with each other by way of network 235 and may be the system or components described below in FIG. 11. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The networks 230, 235 may include wide area networks (“WAN”), such as the internet, mobile networks, local area networks (“LAN”), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N.

The users 120AA-NN may use a mobile application running on a mobile device 220AA-220NN, such as a mobile web browser, to communicate with the service provider server 240, via the MNO gateway servers 215A-N and the networks 230, 235. The service provider server 240 may communicate to the users 120AA-NN via the networks 230, 235 and the MNO gateway servers 215A-N, through the mobile devices 220AA-NN.

The web applications, standalone applications, mobile applications and mobile devices 210A-N, 220AA-NN may be connected to the network 230 in any configuration that supports data transfer. This may include a data connection to the network 230 that may be wired or wireless. Any of the web applications, standalone applications and mobile applications 210A-N, may individually be referred to as a client application. The web application 210A may run on any platform that supports web content, such as a web browser or a computer, a mobile phone, personal digital assistant (“PDA”), pager, network-enabled television, digital video recorder, such as TIVOPR, automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone application 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with a revenue generator B 110B. The communication interface may be operatively connected to the memory, and the processor, and may be capable of communicating through the networks 230, 235 with the service provider server 240, third party server 250 and advertising services server 260. The standalone application 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 210N may run on any mobile device which may have a data connection. The mobile applications 210N may be a web application 210A, a standalone application 210B, a mobile messaging application, a mobile browser, or a microbrowser. The mobile devices 220AA-NN may be one of a broad range of electronic devices which may include mobile phones, PDAs, and laptops and notebook computers. The mobile devices 220AA-NN may have a reduced feature set, such as a smaller keyboard and/or screen, and may be incapable of supporting a traditional web search.

The data connection of the mobile devices 220AA-NN may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the MNO gateway servers 215A-N.

The MNO gateway servers 215A-N may control the access the mobile devices 220AA-NN may have to the network. The MNO gateway servers 215A-N may also control the technology supporting the respective mobile devices 220AA-NN. This may affect aspects of the user experience, such as signal strength and availability, speed and billing mechanisms. For example, the MNO gateway server A 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile devices 220AA-NN may only support one of the aforementioned formats.

The MNOs 115A-N may utilize various components to provide these services to the users 120AA-NN, such as network switching systems (“NSS”), mobile switching centers (“MSC”), mobile switching center servers (“MSC-S”), home location registers (“HLR”), authentication centers (“AUC”), short message service centers (“SMSC”), signal transfer points (“STP”), message service centers (“MSC”), or generally any component that may be utilized to provide the mobile services. The MNOs 115A-N may interface with one or more external short messaging entities (“ESME”), such as the third party server 250, which may connect to the MNOs 115A-N to send and/or receive mobile messages to the users 120AA-NN. The ESMEs may provide voicemail, web, email, or other services to the users 120AA-NN of the MNOs 115A-N.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may collectively be referred to as the server. The service provider server 240 may receive requests from the users 120AA-NN and the revenue generators 110A-N and may serve mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. Alternatively or in addition, the third party server may be an ESME server. The advertising services server 260 may provide a platform for the inclusion of advertisements in pages, such as web pages or mobile pages. The advertisement services server 260 may be used for providing mobile advertisements that may be displayed to the users 120AA-NN.

The service provider server 240, the third party server 250 and the advertising services server 260 may be one or more computing devices of various kinds, such as the computing device in FIG. 11. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (“TCP/IP”) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server may provide a platform for the inclusion of advertisements in pages, such as web pages. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (“LAN”), a wide area network (“WAN”), a direct connection such as through a Universal Serial Bus (“USB”) port, and the like, and may include the set of interconnected networks that make up the Internet. The networks 230, 235 may include any communication method by which information may travel between computing devices.

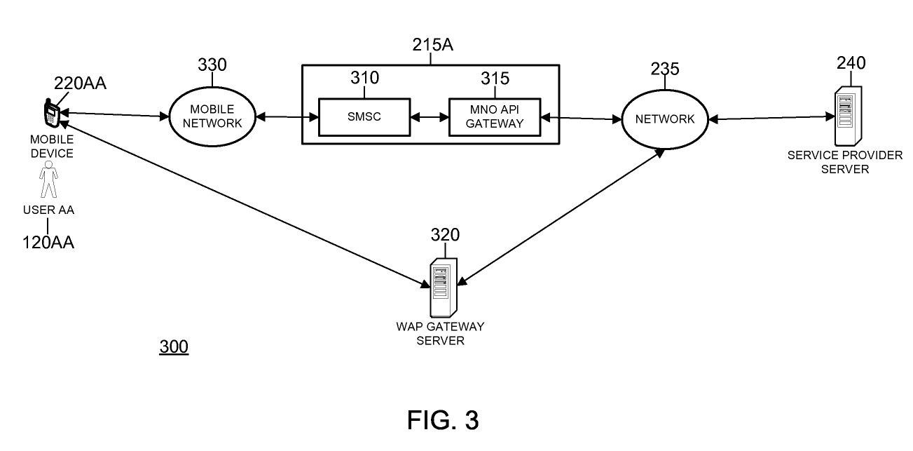

FIG. 3 illustrates a block diagram of an implementation of the system of FIG. 1 or other systems for providing search services over mobile messaging. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 300 may include the service provider server 240, the mobile device 220AA, the user AA 120AA, the MNO A gateway server 215A, the network 235, a mobile network 330, and a WAP gateway server 320. The MNO A gateway server 215A may include a SMSC 310 and a MNO API gateway 315. The SMSC 310 and the MNO API gateway 315 may be running on the same machine, may be running in a distributed configuration, or may be running remotely from each other. The WAP gateway server 320 may be the computing device described in FIG. 11 below. The WAP gateway server 320 may be hosted on one computing device or may be distributed across several computing devices.

In operation, the user AA 120AA may send a mobile message from the mobile device 220AA to a target phone number on the MNO A 115A, such as “411”. The mobile message may be an short messaging service (“SMS”) message, a multimedia messaging system message (“MMS”), or generally any mobile message. The mobile message may include a search query such as “Chicago hotel.” The mobile message may be delivered by the mobile device 220AA to the SMSC 310 of the MNO A gateway server 215A. The SMSC 310 may route the mobile message to the MNO API gateway 315 via implementation or operator specific protocols, such as short message peer-to-peer protocol (“SMPP”), common channel signaling system 7 (“SS7”), Chinese Mobile peer to peer (“CMPP”), global system for mobile communications (“GSM”) mobile application part (“MAP”), or push access protocol (“PAP”). The SS7 may be an out-of-band signaling system for public switched telephone networks (“PSTNs”) and public land mobile networks (“PLMNs”). SS7 may describe procedures for connection setup, management, and tear down, as well as protocols used by network elements to exchange billing and routing information. The MAP may be an application layer on top of SS7. MAP may provide procedures for location management, authentication, call handling, subscriber tracing and SMS management.

The MNO API gateway 315 may send the message to the service provider server 240 via a hyper-text transport protocol (“HTTP”) get message. The service provider 240 may perform the search and retrieve the search results and targeted advertisements. The search results and targeted advertisements may be formatted into an XML message and provided to the MNO API gateway 315 via an HTTP response message. The MNO API gateway 315 may transform the search results and advertisements in the XML file into a mobile message, such as a WAP push message. The mobile message may contain encoded links to the mobile or WAP pages related to the mobile advertisements. The links may be encoded with a service indication, which may cause the mobile device 220AA of the user AA 120AA to open a mobile browser when the user AA 120AA clicks on a link in the mobile message. The browser may be opened to the mobile page or WAP page represented by the link. The MNO API gateway 315 may send the message back to the SMSC 310 using the aforementioned protocols.

The SMSC 310 delivers the message to the user AA 120AA on the mobile device 220AA. The user AA 120AA may then open the mobile message on the mobile device 220AA. If the user AA 120AA clicks on an item in the message, such as a search result or advertisement, the service indication may cause the mobile device 220AA to open a browser. The browser may open to the mobile page referenced by the search result or advertisement. The request to retrieve the page may be handled by the WAP gateway server 320. The WAP gateway server 320 may return the requested page to the mobile device 220AA of the user AA 120AA. Alternatively or in addition the service indication may cause the mobile device 220AA to make a call to a phone number associated with an advertisement or search result. The service provider server 240 and/or the WAP gateway server 320 may track user clicks to determine if a user AA 120AA clicks on a search result or advertisement.

The user AA 120AA may not be charged a fee for sending the search request via the mobile message. The fee associated with sending the mobile message may be charged to a revenue generator A 110A whose advertisement is displayed with the search result. Alternatively or in addition the revenue generator A 110A may only be charged if the user AA 120AA clicks on the advertisement of the revenue generator A 110A. The advertisement of a revenue generator A 110A may include a coupon or a discount that is only valid for a set period of time. Alternatively or in addition the user AA 120AA may participate in a random draw system where the search result and/or advertisement returned to the user AA 120AA may be selected at random. The random system may expose the user AA 120AA to new products and/or services.

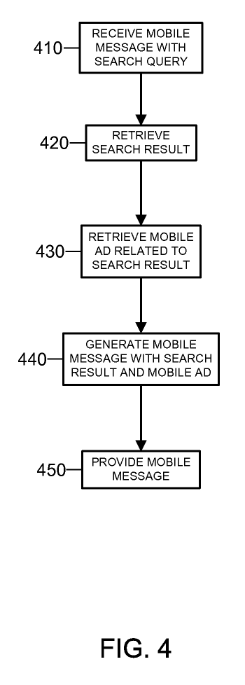

FIG. 4 is a flowchart illustrating operations of providing a search result and targeted advertisement over a mobile message in the system of FIG. 1 or other systems for providing search services over mobile messaging. At block 410 the service provider 130 may receive a mobile message containing a search query, such as from the user AA 120AA on the mobile device 220AA. The mobile message may be forwarded by the MNO A 115A to the service provider 130. At block 420 the service provider 130 may retrieve the search results of the search query. At block 430 the service provider 130 may retrieve a mobile advertisement related to the search results, such as by using a search advertising mechanism. At block 440 the service provider 130 may generate a mobile message containing the search result and the mobile advertisement. The mobile message may be an SMS message, an MMS message, a WAP push message, or generally any mobile message. The service provider 130 may verify that the mobile message does not exceed a maximum length for the mobile device 220AA or the MNO A 115A. At block 450 the service provider 130 may provide the mobile message to the mobile device 220AA of the user AA 120AA.

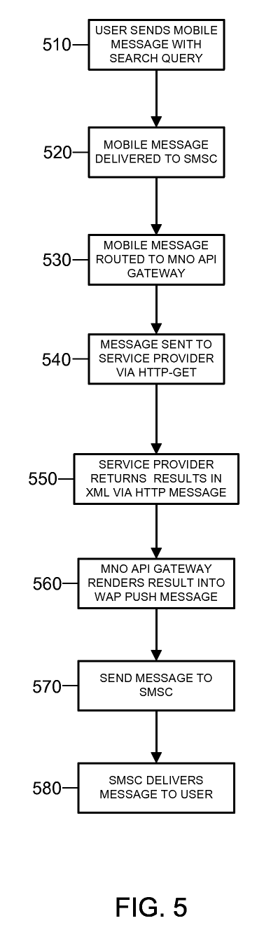

FIG. 5 is a flowchart illustrating network operations of providing a search result and targeted advertisement to a user over mobile messaging in the systems of FIG. 1, or other systems for providing search services over mobile messaging. At block 510 the user AA 120AA may send a mobile message containing a search query to a number specified for the MNO A 115A, such as “411.” At block 520 the mobile message may be delivered to the SMSC 310 of the MNO A 115A. At block 530 the SMSC 310 may route the message to the MNO API gateway 315 using implementation specific protocols. At block 540 the MNO API gateway 315 may send the mobile message to the service provider 130 using an HTTP get message. At block 550 the service provider 130 retrieves the search results and an advertisement and returns the results, formatted in XML, via an HTTP response message. At block 560 the MNO API gateway 315 transforms the XML formatted search results and/or advertisements into a mobile message, such as a WAP push message. At block 570 the MNO API gateway 315 routes the message to the SMSC 310. At block 580 the SMSC 310 delivers the message to the mobile device 220AA of the user AA 120AA using a mobile messaging service.

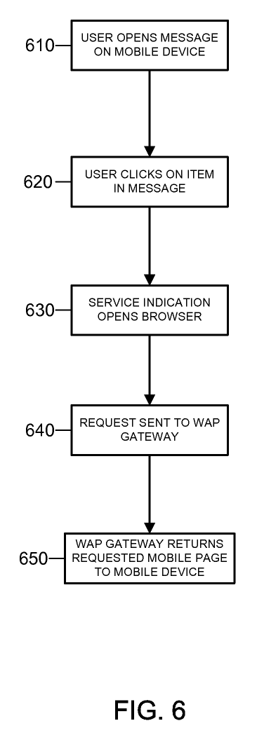

FIG. 6 is a flowchart illustrating operations of displaying search results in the system of FIG. 1, or other systems for providing search services over mobile messaging. At block 610 the user AA 120AA opens a mobile message containing search results on the mobile device 220AA. The mobile device 220AA may display one or more search results and one or more advertisements. Each of the search results and advertisements may have been encoded with a service indication such that the mobile device 220AA may open a browser to the referenced mobile page when clicked on. At block 620 the user AA 120AA may click on an item in the mobile message, such as a search result. At block 630 the service indication may cause the mobile device 220AA to open a browser. At block 640 the browser may request the mobile page referenced by the search result, such as a WAP page, from the WAP gateway server 320. At block 650 the WAP gateway server 320 may return the requested mobile page to the mobile device 220AA of the user 120AA. The mobile page may be displayed in the browser on the mobile device 220AA.

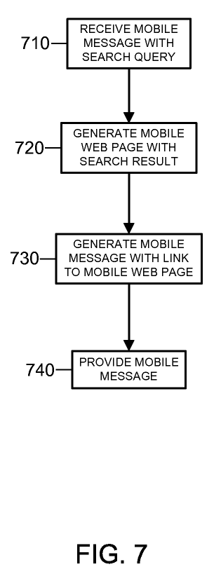

FIG. 7 is a flowchart illustrating operations of providing a link to search results in a mobile message in the system of FIG. 1, or other systems for providing search services over mobile messaging. At block 710 the service provider 130 may receive a mobile message containing a search query from a user AA 120AA on a mobile device 220AA. At block 720 the service provider 130 may generate a mobile web page containing search results for the search query and related advertisements. The mobile web page may be hosted by the service provider 130. At block 730 the service provider 130 may generate a mobile message containing a link to the mobile web page. The mobile message may be encoded with a service indication which may cause a link to be opened in a browser when clicked on. At block 740 the service provider 130 may provide the mobile message to the user AA 120AA on the mobile device 220AA. The user AA 120AA may open the mobile message and click on an item in the mobile message, such as a search result or advertisement. The mobile device 220AA may open a browser to the page referenced by the item clicked on by the user AA 120AA. The user AA 120AA may then complete a transaction with one of the revenue generators 110A-N, or may call one of the revenue generators to complete a transaction.

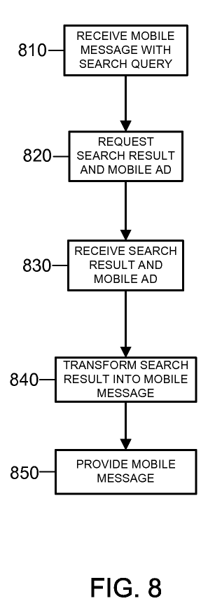

FIG. 8 is a flowchart illustrating operations of a mobile network operator in the system of FIG. 1, or other systems for providing search services over mobile messaging. At block 810 one of the MNOs 115A-N, such as the MNO A 115A, may receive a mobile message containing a search query, such as from a user 120AA on a mobile device 220AA. At block 820 the MNO A 115A may request search results and an advertisement from the service provider 230 related to the search query. At block 830 the MNO A 115A may receive a search result and an advertisement from the service provider 130. At block 840 the MNO A 115A may transform the search result and the advertisement into a mobile message, such as a WAP push message. The mobile message may include the search result, the advertisement, links to mobile pages related to the search result and advertisement, and a service indication. The service indication may cause the mobile device 220AA to display the mobile pages when the links are clicked on by the user AA 120AA. At block 850 the MNO A 115A may provide the mobile message to the user AA 120AA via the mobile device 220AA.

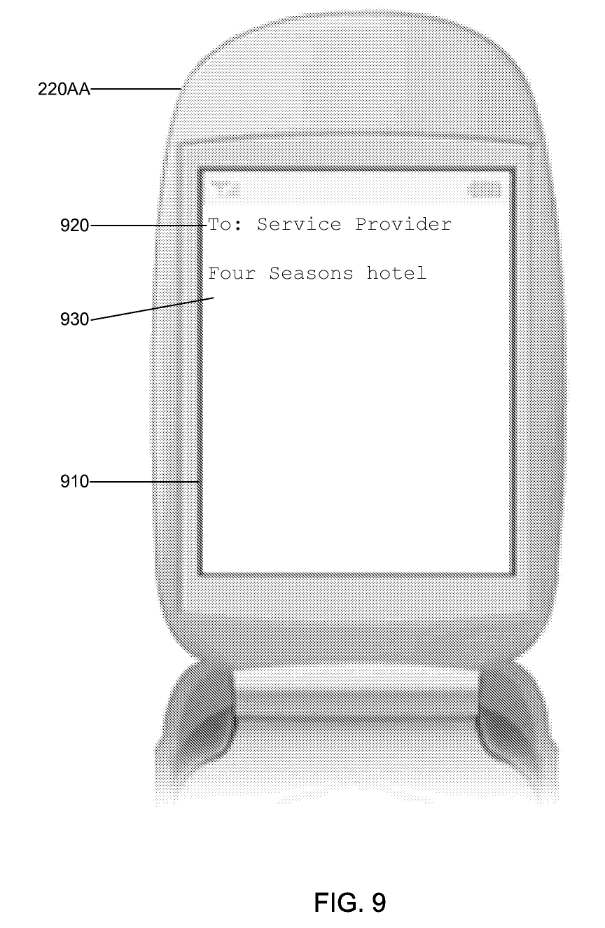

FIG. 9 illustrates a mobile device 220AA displaying a mobile message containing a search query in the system of FIG. 1 or other systems for providing search services over mobile messaging. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The mobile device 220AA of the user AA 120AA may include a display 910. When preparing a mobile message, the display 910 may display the addressee 920 of the message, and the body 930 of the message. For example, in FIG. 9, the body 930 of the mobile message from the user AA 120AA is a search query for “Four Seasons hotel.” The addressee 920 of the mobile message is the service provider 130. The user AA 120AA may send the search query to the service provider 130 and may receive the results of the search query in a mobile message from the service provider 130, such as a WAP push message.

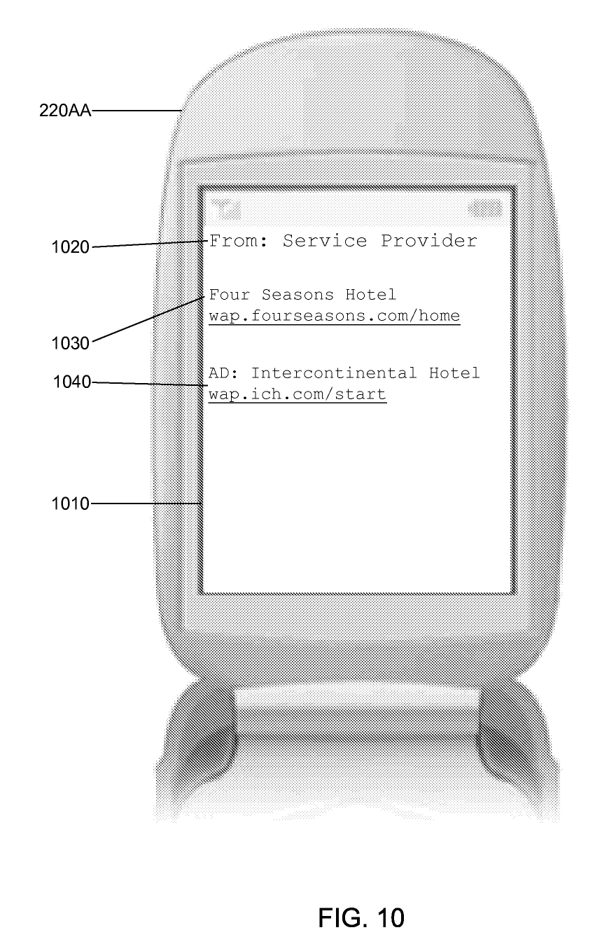

FIG. 10 illustrates a mobile device 220AA displaying a mobile message containing a mobile search result and a targeted mobile advertisement in the system of FIG. 1 or other systems for providing search services over mobile messaging. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The mobile device 220AA may include a display 1010. The display 1010 may display a mobile message containing a sender 1020, a search result 1030 and an advertisement 1040. The advertisement 1040 may relate to the search query, the search result 1030, or may generally relate to the user AA 120AA. Alternatively or in addition the mobile message may include a service indication. The service indication may cause a browser to open to the referenced URL when the user AA 120AA clicks on the search result 130 or the mobile advertisement 1040.

FIG. 11 illustrates a general computer system 1100, which may represent a service provider server 240, a third party server 250, an advertising services server 260, a WAP gateway server 320, one of the mobile devices 220AA-NN or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 1100 may include a set of instructions 1124 that may be executed to cause the computer system 1100 to perform any one or more of the methods or computer based functions disclosed herein. The computer system 1100 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1100 may also be implemented as or incorporated into various devices, such as a personal computer (“PC”), a tablet PC, a set-top box (“STB”), a personal digital assistant (“PDA”), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1124 (sequential or otherwise) that specify actions to be taken by that machine. In a particular embodiment, the computer system 1100 may be implemented using electronic devices that provide voice, video or data communication. Further, while a single computer system 1100 may be illustrated, the term “system” shall also be taken to include any collection of systems or sub-systems that individually or jointly execute a set, or multiple sets, of instructions to perform one or more computer functions.

As illustrated in FIG. 11, the computer system 1100 may include a processor 1102, such as, a central processing unit (“CPU”), a graphics processing unit (“GPU”), or both. The processor 1102 may be a component in a variety of systems. For example, the processor 1102 may be part of a standard personal computer or a workstation. The processor 1102 may be one or more general processors, digital signal processors, application specific integrated circuits, field programmable gate arrays, servers, networks, digital circuits, analog circuits, combinations thereof, or other now known or later developed devices for analyzing and processing data. The processor 1102 may implement a software program, such as code generated manually (i.e., programmed).

The computer system 1100 may include a memory 1104 that can communicate via a bus 1108. The memory 1104 may be a main memory, a static memory, or a dynamic memory. The memory 1104 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1104 may include a cache or random access memory for the processor 1102. Alternatively or in addition, the memory 1104 may be separate from the processor 1102, such as a cache memory of a processor, the system memory, or other memory. The memory 1104 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1104 may be operable to store instructions 1124 executable by the processor 1102. The functions, acts or tasks illustrated in the figures or described herein may be performed by the programmed processor 1102 executing the instructions 1124 stored in the memory 1104. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1100 may further include a display 1114, such as a liquid crystal display (“LCD”), an organic light emitting diode (“OLED”), a flat panel display, a solid state display, a cathode ray tube (“CRT”), a projector, a printer or other now known or later developed display device for outputting determined information. The display 1114 may act as an interface for the user to see the functioning of the processor 1102, or specifically as an interface with the software stored in the memory 1104 or in the drive unit 1106.

Additionally, the computer system 1100 may include an input device 1112 configured to allow a user to interact with any of the components of system 1100. The input device 1112 may be a number pad, a keyboard, or a cursor control device, such as a mouse, or a joystick, touch screen display, remote control or any other device operative to interact with the system 1100.

The computer system 1100 may also include a disk or optical drive unit 1106. The disk drive unit 1106 may include a computer-readable medium 1122 in which one or more sets of instructions 1124, e.g. software, can be embedded. Further, the instructions 1124 may perform one or more of the methods or logic as described herein. The instructions 1124 may reside completely, or at least partially, within the memory 1104 and/or within the processor 1102 during execution by the computer system 1100. The memory 1104 and the processor 1102 also may include computer-readable media as discussed above.

The present disclosure contemplates a computer-readable medium 1122 that includes instructions 1124 or receives and executes instructions 1124 responsive to a propagated signal; so that a device connected to a network 235 may communicate voice, video, audio, images or any other data over the network 235. The instructions 1124 may be implemented with hardware, software and/or firmware, or any combination thereof. Further, the instructions 1124 may be transmitted or received over the network 235 via a communication interface 1118. The communication interface 1118 may be a part of the processor 1102 or may be a separate component. The communication interface 1118 may be created in software or may be a physical connection in hardware. The communication interface 1118 may be configured to connect with a network 235, external media, the display 1114, or any other components in system 1100, or combinations thereof. The connection with the network 235 may be a physical connection, such as a wired Ethernet connection or may be established wirelessly as discussed below. Likewise, the additional connections with other components of the system 1100 may be physical connections or may be established wirelessly. In the case of a service provider server 240, a third party server 250, an advertising services server 260, the servers may communicate with users 120AA-NN and the revenue generators 110A-N through the communication interface 1118.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 1122 may be a single medium, or the computer-readable medium 1122 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1122 may include a solid-state memory such as a memory card or other package that houses one or more non-volatile read-only memories. The computer-readable medium 1122 also may be a random access memory or other volatile re-writable memory. Additionally, the computer-readable medium 1122 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A computer implemented method of providing search services over mobile messaging, comprising:
receiving a first mobile message from a mobile device over a mobile messaging service, the mobile message comprising of a search query;
retrieving a search result of the search query;
retrieving a mobile advertisement related to the search result, wherein the mobile advertisement comprises a link to a mobile web page related to the mobile advertisement;
generating a second mobile message comprising the search result and the mobile advertisement; and
providing the second mobile message to the mobile device over the mobile messaging service.

2. The computer implemented method of claim 1 wherein the second mobile message further comprises a service indication to open a browser on the mobile device to the mobile web page related to the advertisement.

3. The computer implemented method of claim 2 wherein the service indication causes the mobile device to open the browser to the mobile web page related to the advertisement when the link of advertisement is clicked on by a user of the mobile device.

4. The computer implemented method of claim 1 wherein the search result comprises of a second link to a second mobile web page.

5. The computer implemented method of claim 1 further comprising:
determining a mobile network operator of the mobile device; and
verifying that a length of the second mobile message does not exceed a maximum message length of the mobile network operator.

6. The computer implemented method of claim 1 further comprising receiving an indication of a location of the mobile device.

7. The computer implemented method of claim 6 wherein retrieving a search result of the search query further comprises retrieving a search result of the search query, the search result related to the location of the mobile device.

8. The computer implemented method of claim 6 wherein retrieving a mobile advertisement related to the search result further comprises retrieving a mobile advertisement targeted to the search result and the location of the mobile device.

9. The computer implemented method of claim 1 wherein a user of the mobile device is not charged a messaging fee for receiving the second mobile message.

10. The computer implemented method of claim 9 wherein the messaging fee is charged to an advertiser associated with the mobile advertisement.

11. The computer implemented method of claim 1 wherein a user of the mobile device is not charged a messaging fee for receiving the second mobile message if the user clicks on the link.

12. The computer implemented method of claim 1 further comprising determining a mobile network operator of the mobile device.

13. The computer implemented method of claim 12 wherein retrieving a mobile advertisement related to the search result further comprises retrieving a mobile advertisement related to the search result and targeted to the mobile network operator.

14. The computer implemented method of claim 1 wherein the mobile messaging service comprises a short messaging service.

15. A computer implemented method of providing mobile search over a mobile messaging service, comprising:
receiving a first mobile message from a mobile device over a mobile messaging service, the first mobile message comprising of a search query;
generating a mobile web page comprising of a search result of the search query and a mobile advertisement;
generating a second mobile message, the second mobile message comprising of a link to the mobile web page; and
providing the second mobile message to the mobile device over the mobile messaging service.

16. The computer implemented method of claim 15 wherein the second mobile message further comprises a service indication to open a browser on the mobile device.

17. The computer implemented method of claim 16 wherein the service indication causes the mobile device to open the browser to the mobile web page when the link of advertisement is clicked on.

18. The computer implemented method of claim 15 further comprising:
detecting whether the link is clicked on by a user of the mobile device; and
storing an indication of whether the link is clicked on by the user, the indication comprising of an identifier of the mobile device.

19. A computer implemented method of providing mobile search results over a mobile messaging service, comprising:
receiving a first mobile message from a mobile device over a mobile messaging service, the first mobile message comprising of a search query;
requesting a search result of the search query and an advertisement;
receiving the search result and the advertisement, wherein the search result and the advertisement are formatted in a markup language;
transforming the search result and the advertisement into a second mobile message; and
providing the second mobile message to the mobile device over the mobile messaging service.

20. The computer implemented method of claim 19 wherein the second mobile message further comprises a service indication to open a browser on the mobile device.

21. The computer implemented method of claim 20 wherein the service indication causes the mobile device to open the browser to the mobile web page when the link of advertisement is clicked on.

22. A system for serving mobile advertisements over mobile messaging services, comprising:
a memory to store a search result and a mobile advertisement related to the search result, the mobile advertisement comprising of a link to a mobile web page related to the mobile advertisement;
an interface operatively connected to the memory, the interface to communicate with a mobile device over a mobile messaging service; and
a processor operatively connected to the memory and the interface the processor for running instructions, wherein the processor receives a first mobile message from the mobile device via the interface, the first mobile message comprising of a search query, retrieves the search result of the search query, retrieves the mobile advertisement related to the search result, generates a second mobile message comprising of the search result and the mobile advertisement, and provides the second mobile message to the mobile device over a mobile messaging service.

23. The system of claim 22 wherein the second mobile message further comprises a service indication to open a browser on the mobile device.

24. The system of claim 22 wherein the service indication causes the mobile device to open the browser to the mobile web page when the link of advertisement is clicked on.

25. The system of claim 22 wherein a messaging fee associated with providing the second mobile message to the mobile device is charged to an advertiser associated with the mobile advertisement instead of a user of the mobile device.
